(19) United States
(12) Patent Application Publication
(10) Pub. No.: US 2026/0116474 A1
(43) Pub. Date: Apr. 30, 2026

(54) Tow Truck Dolly Fenders Kit

(71) Applicants: Brian Omiecinski, Chicago, IL (US); Aldo Reyes, Chicago, IL (US)

(72) Inventors: Brian Omiecinski, Chicago, IL (US); Aldo Reyes, Chicago, IL (US)

(21) Appl. No.: 19/004,591

(22) Filed: Dec. 30, 2024

Related U.S. Application Data
(60) Provisional application No. 63/625,018, filed on Jan. 25, 2024.

(51) Int. Cl. B62D 25/16; B60R 19/00

(52) U.S. Cl. CPC B62D 25/163; B62D 25/168; B60R 2019/002

(57) ABSTRACT

A tow truck dolly fenders kit designed to enhance the functionality and safety of tow dollies, as described. The kit includes a pair of durable fenders, a front fender aligned with a rear fender, each shaped to contour over at least the top of the dolly wheels or tires for providing a protective shield against debris and hazards. A central bracket is positioned between the fenders and facilitates easy, secure attachment to the tow dolly without the need for drilling or permanent modifications. The bracket is integrated with the fenders via a connecting member and extends below thereof for straightforward mounting. The fenders are equipped with multiple reflectors to enhance visibility in low-light conditions, ensuring safe navigation. The kit is made from robust materials such as aluminum or steel and may include apertures for additional securement and an anti-corrosion coating for enhanced durability.

### CROSS-REFERENCE TO RELATED APPLICATION

The present application claims priority to, and the benefit of, U.S. Provisional Application No. 63/625,018 which was filed on Jan. 25, 2024 and is incorporated herein by reference in its entirety.

### FIELD OF THE INVENTION

The present invention generally relates to the field of towing accessories. More specifically, the present invention pertains to a tow truck dolly fenders kit designed to protect towed vehicles from environmental hazards and street debris. The fenders kit includes a pair of durable fenders, shaped to contour over the top of dolly wheels or tires, and a central bracket for easy installation without permanent modifications. The fenders are integrated via a connecting member and feature multiple reflectors to enhance visibility. The kit provides reliable protection and improved safety for towing operations. Accordingly, the present disclosure makes specific reference thereto. Nonetheless, it is to be appreciated that aspects of the present invention are also equally applicable to other like applications, devices, and methods of manufacture.

### BACKGROUND

By way of background, a tow dolly is a flat platform with wheels that is used to transport a vehicle by towing it behind another vehicle. A tow dolly generally has two wheels at the front and a coupler to attach it to the towing vehicle. When using a tow dolly, the towed vehicle may be at risk of damage due to various environmental and road conditions. Inclement weather, such as rain, snow, and hail, can adversely affect the towed vehicle, leading to potential damage to its body paint and structural components. Additionally, street debris, including rocks, gravel, and other objects, can be kicked up by the wheels of the tow dolly, causing scratches, dents, and other forms of damage to the towed vehicle.

Currently, there is no effective solution to protect the towed vehicle from these hazards. This lack of protection can lead to expensive insurance claims to cover the cost of repairs, resulting in financial burdens for the vehicle owner. Moreover, the debris kicked up by the tow dolly can also pose a risk to other vehicles on the road, potentially causing accidents or damage to those vehicles. The towed vehicle is also not clearly visible to the tow truck driver as there is no indication of how wide the towed vehicle is to navigate the road at night. Individuals desire a protective system that can shield the towed vehicle and enhance road safety.

Therefore, there exists a long-felt need in the art for an effective solution to protect towed vehicles from damage during towing operations. There is also a long-felt need in the art for a tow dolly fenders kit that shields the towed vehicle from inclement weather, such as rain, snow, and hail, as well as street debris like rocks and gravel. Additionally, there is a long-felt need in the art for a protective system that can be easily installed on existing tow dollies without requiring drilling or permanent modifications. Moreover, there is a long-felt need in the art for a fenders kit that enhances the safety of other vehicles on the road by preventing debris from being kicked up by the tow dolly wheels or tires. Further, there is a long-felt need in the art for a durable, reliable fenders kit made from high-quality materials like aluminum or steel, ensuring longevity and resilience against harsh conditions. Furthermore, there is a long-felt need in the art for a fenders kit that includes reflectors to enhance visibility, particularly in low-light conditions, thereby improving the safety of towing operations. Finally, there is a long-felt need in the art for a tow dolly fenders kit that offers comprehensive protection for both the towed vehicle and other road users, reducing the risk of damage and associated costs.

The subject matter disclosed and claimed herein, in one embodiment thereof, comprises a tow truck dolly fenders kit. The fenders kit includes a pair of fenders, each pair of fenders having a front fender and a rear fender, each shaped to contour over the top of dolly wheels or tires, providing a protective shield against debris, mud, and other hazards encountered during towing. The kit further includes a central bracket positioned between the aligned fenders, adapted for easy installation and secure attachment to a tow dolly without the need for drilling or permanent modifications. A connecting member integrates the bracket and the aligned front and rear fenders, with the bracket extending below the connecting member for straightforward mounting. The front and rear fenders are equipped with multiple reflectors to enhance visibility, ensuring safe navigation in low-light conditions. The fenders and the bracket are made from durable materials such as aluminum or steel, ensuring robustness and longevity. The bracket may also include apertures for additional securement to the tow dolly frame.

In this manner, the tow truck dolly fenders kit of the present invention accomplishes all of the foregoing objectives and provides users with a novel solution for protecting towed vehicles and enhancing towing safety. The fenders kit effectively shields the towed vehicle from environmental hazards and street debris, minimizing the risk of damage and expensive repair costs. The central bracket and connecting member enable for easy and secure attachment to existing tow dollies, ensuring compatibility without the need for permanent modifications. The inclusion of multiple reflectors enhances visibility, particularly in low-light conditions, improving the safety of towing operations for both the tow truck driver and other road users. The use of durable materials like aluminum or steel ensures the fenders kit can withstand harsh conditions and prolonged use, offering reliable protection and longevity.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tow truck dolly fenders kit for protecting the wheels of a tow dolly. The fenders kit comprises a pair of fender kits wherein each fender kit including a front fender and a rear fender, each fender being shaped to contour over the top of the dolly wheels or tires to provide a protective shield, a bracket positioned between the front fender and the rear fender, the bracket being adapted for easy installation on a tow dolly by clipping or sliding onto the tow dolly without the need for drilling or permanent modifications, wherein the fenders and the bracket are made from durable materials selected from aluminum or steel, and a plurality of reflectors attached to each fender for enhancing visibility.

In yet another embodiment, a tow truck dolly fenders kit and tow dolly assembly is disclosed. The assembly comprises a tow dolly, a front fender and a rear fender, each shaped to contour over the top of dolly wheels or tires to provide a protective shield, a bracket positioned at the center between the front fender and the rear fender, adapted for easy installation and secure attachment to the tow dolly without the need for drilling or permanent modifications, a connecting member integrating the bracket and the fenders, wherein the bracket extends below the connecting member for easy mounting, wherein the bracket includes apertures for screwing the bracket to the frame of the tow dolly.

In another embodiment, a towing system is disclosed. The system comprises a tow dolly configured for towing vehicles, the tow dolly including an arm and a frame, a fenders kit including a front fender and a rear fender, each shaped to contour over the top of dolly wheels or tires to provide a protective shield, a bracket positioned at the center between the front fender and the rear fender, adapted for easy installation and secure attachment to the tow dolly, a plurality of reflectors on each fender for enhancing visibility in low-light conditions, wherein the bracket includes apertures for screwing the bracket to the frame of the tow dolly. The towing system enhances the safety and functionality of towing operations by protecting the dolly wheels or tires and towed vehicle from debris and providing increased visibility through the reflectors.

In still another embodiment, the reflectors are positioned on the front and rear ends of each fender to maximize visibility from multiple angles.

In another aspect, the fenders kit further includes an anti-corrosion coating on the fenders and the bracket to enhance durability and longevity in various environmental conditions.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the tow truck dolly fenders kit of the present invention in accordance with the disclosed structure;

FIG. 2 illustrates a perspective view showing the tow truck dolly fenders kit of the present invention clipped onto an exemplary tow dolly in accordance with the disclosed structure;

FIG. 3 illustrates a flow chart depicting a process of use of the durable tow dollies fender system with reflectors of the present invention in accordance with the disclosed structure; and

FIG. 4 illustrates a top view of the multifunctional tow truck dolly fenders kit of the present invention in accordance with one embodiment of the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an effective solution to protect towed vehicles from damage during towing operations. There is also a long-felt need in the art for a tow dolly fenders kit that shields the towed vehicle from inclement weather, such as rain, snow, and hail, as well as street debris like rocks and gravel. Additionally, there is a long-felt need in the art for a protective system that can be easily installed on existing tow dollies without requiring drilling or permanent modifications. Moreover, there is a long-felt need in the art for a fenders kit that enhances the safety of other vehicles on the road by preventing debris from being kicked up by the tow dolly wheels or tires. Further, there is a long-felt need in the art for a durable, reliable fenders kit made from high-quality materials like aluminum or steel, ensuring longevity and resilience against harsh conditions. Furthermore, there is a long-felt need in the art for a fenders kit that includes reflectors to enhance visibility, particularly in low-light conditions, thereby improving the safety of towing operations. Finally, there is a long-felt need in the art for a tow dolly fenders kit that offers comprehensive protection for both the towed vehicle and other road users, reducing the risk of damage and associated costs.

The present invention, in one exemplary embodiment, is a towing system. The system comprises a tow dolly configured for towing vehicles, the tow dolly including an arm and a frame, a fenders kit including a front fender coupled with an aligned rear fender, each shaped to contour over the top of dolly wheels or tires to provide a protective shield, a bracket positioned at the center between the front fender and the rear fender, adapted for easy installation and secure attachment to the tow dolly, a plurality of reflectors on each fender for enhancing visibility in low-light conditions, wherein the bracket includes apertures for screwing the bracket to the frame of the tow dolly. The towing system enhances the safety and functionality of towing operations by protecting the dolly wheels or tires and towed vehicle from debris and providing increased visibility through the reflectors.

Reference will now be made in detail to the present preferred embodiments of the invention, examples of which are illustrated in the accompanying drawings. Wherever possible, the same reference numerals are used in the drawings and the description to refer to the same or like parts.

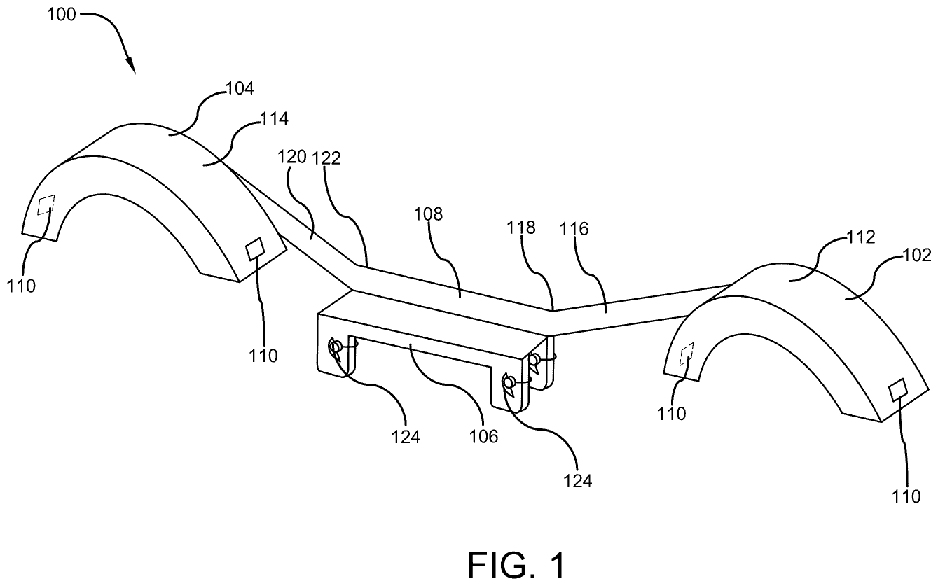

Referring initially to the drawings, FIG. 1 illustrates a perspective view of the tow truck dolly fenders kit of the present invention in accordance with the disclosed structure. The tow truck dolly fenders kit 100 of the present invention is designed as a specialized accessory to enhance the functionality and safety of tow dollies used in towing operations. The kit 100 includes a pair of fenders including a front fender 102 aligned with a rear fender 104. The fenders 102, 104 are shaped to contour over the top of the dolly wheels or tires, thereby providing a protective shield. Preferably, the fenders 102, 104 are curved and the curvature ensures maximum coverage (i.e., coverage of at least 180 degrees or half of the outer circumference of the tire), protecting against debris, mud, and other hazards encountered during towing. The fenders 102, 104 are sized to fit the specific dimensions of standard tow dolly wheels or tires, ensuring a snug fit that doesn't interfere with the dolly's operation.

The fenders system 100 includes a bracket 106 preferably positioned at the center between the fenders 102, 104. The bracket 106 is adapted for easy installation of the fenders system 100 on a tow dolly and can be clipped-on or slid across a tow dolly arm or axle 202 of the tow dolly. The bracket 106 enables the fenders system 100 to be securely attached to the existing structure of the tow dolly without the need for drilling or permanent modifications.

The fenders kit 100 preferably has a one-piece construction and the bracket 106 and the fenders 102, 104 are integrated using a connecting member 108. Preferably, the bracket 106 extends below the connecting member 108 enabling the fenders kit 100 to be easily mounted to a tow dolly. The fenders 102, 104 are made from durable materials like aluminum or steel to ensure longevity and resilience against harsh conditions. The bracket 106 is preferably made from the same durable materials as the fenders 102, 104 to ensure a secure and robust connection.

Each fender 102, 104 includes a plurality of reflectors 110 on the outer surfaces 112, 114 of the fenders 102, 104 for enhancing visibility, making it easier for the tow truck driver to see the edges of the towed vehicle in the mirrors. The reflectors 110 help users navigating safely at night or in low-visibility conditions.

A first arm 116 extends from the one end 118 of the connecting member 108 to the front or first fender 102 and a second arm 120 extends from the opposite end 122 of the connecting member 108 to the rear or second fender 104. The bracket 106 is integrated to the connecting member 108 and can be slid and fastened to any conventional tow dolly.

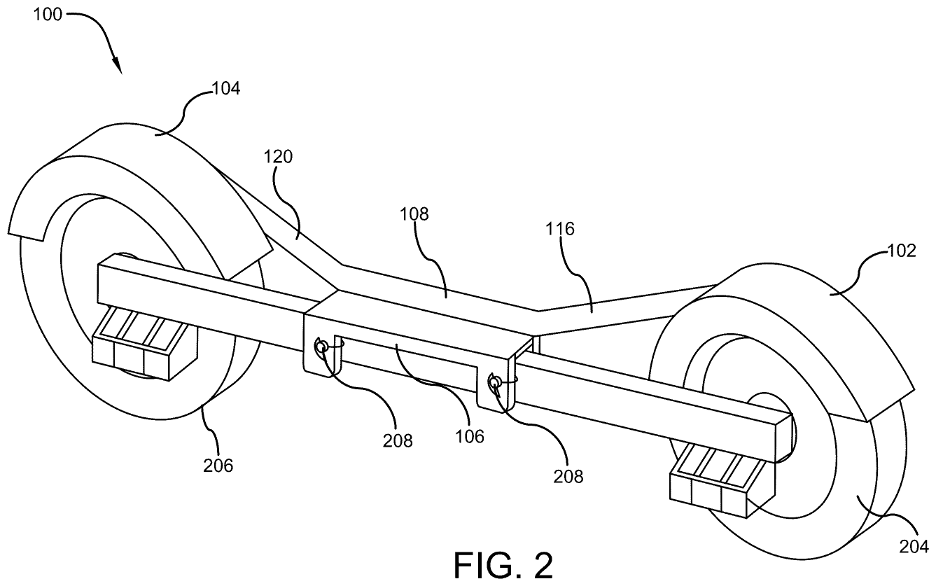

FIG. 2 illustrates a perspective view showing the tow truck dolly fenders kit of the present invention clipped onto an exemplary tow dolly in accordance with the disclosed structure. As illustrated, the bracket 106 is slid onto the tow dolly arm or axle 202 and the fenders 102, 104 are positioned above the dolly tires 204, 206 respectively to protect the tires and to protect the towed vehicle as well. The bracket 106 can include a first pair of opposing apertures 124 and a second pair of opposing apertures 124 for screwing the bracket 106 to the frame of the tow dolly using fasteners 208 for secure attachment of the fenders kit 100. It will be apparent to a person skilled in the art that the fenders kit 100 can come in different sizes and shapes and the fenders 102, 104 can be contoured to cover different sizes of tow dolly tires. In one embodiment, the arms 116, 120 are adjustable and can be adjusted relative to the connecting member 108 for adjusting height of the fenders 102, 104 for covering the tires of the tow dolly.

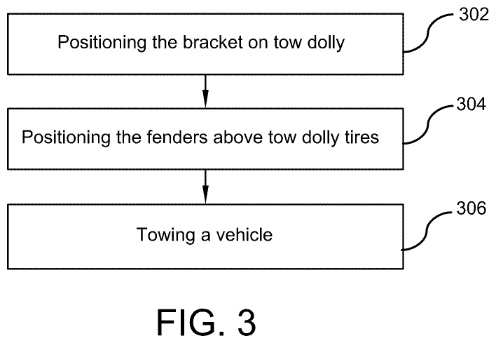

FIG. 3 illustrates a flow chart depicting a process of use of the durable tow dollies fender system with reflectors of the present invention in accordance with the disclosed structure. Initially, the central bracket 106 of the fenders kit is positioned on the arm of a tow dolly (Step 302). The bracket 106 can be secured to the tow dolly arm by clipping or sliding the bracket onto the arm. Then, the fenders 102, 104 are adjusted and positioned above the dolly wheels or tires for providing a protective shield against debris, mud, and other hazards (Step 304). Thereafter, a vehicle is towed on the tow dolly such that the vehicle is protected from external elements by the fenders kit (Step 306).

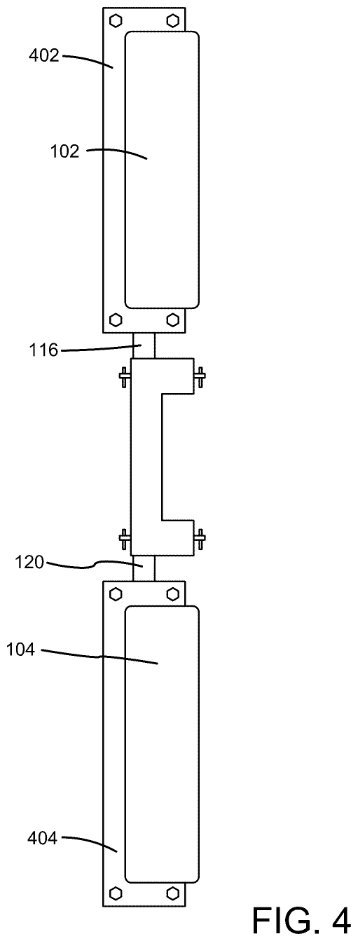

FIG. 4 illustrates a top view of the multifunctional tow truck dolly fenders kit of the present invention in accordance with one embodiment of the disclosed structure. The fenders 102, 104 are curved and can include additional supporting members 402, 404 respectively for additional durability and support. The arms 116, 120 are integrated to the additional supporting members 402, 404 and extend from the connecting member 108.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “durable tow dollies fender system with reflectors”, “tow truck dolly fenders kit”, “multifunctional tow truck dolly fenders kit”, and “fenders kit” are interchangeable and refer to the multifunctional tow truck dolly fenders kit 100 of the present invention.

Notwithstanding the forgoing, the multifunctional tow truck dolly fenders kit 100 of the present invention can be of any suitable size and configuration as is known in the art without affecting the overall concept of the invention, provided that it accomplishes the above stated objectives. One of ordinary skill in the art will appreciate that the multifunctional tow truck dolly fenders kit 100 as shown in the FIGS. are for illustrative purposes only, and that many other sizes and shapes of the multifunctional tow truck dolly fenders kit 100 are well within the scope of the present disclosure. Although the dimensions of the multifunctional tow truck dolly fenders kit 100 are important design parameters for user convenience, the multifunctional tow truck dolly fenders kit 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tow dolly fenders kit comprising:
a front fender;
a rear fender;
a bracket;
a first arm;
a second arm; and
a connecting member;
wherein said front fender having a contoured shape for extending over at least a top portion of a front tow dolly tire;
wherein said rear fender having a contoured shape for extending over at least a top portion of a rear tow dolly tire;
wherein said bracket positioned at a center between said front fender and said rear fender;
wherein said connecting member attached to said bracket;
wherein said front fender connected to said connecting member with said first arm;
wherein said rear fender connected to said connecting member with said second arm; and
further wherein said bracket clippable to a tow dolly arm for attaching said tow dolly fenders kit to the tow dolly.

2. The tow dolly fenders kit of claim 1, wherein said front fender having a contoured shape for extending over at least half of the outer circumference of said front tire.

3. The tow dolly fender kit of claim 2, wherein said rear fender having a contoured shape for extending over at least half of the outer circumference of said rear tire.

4. The tow dolly fender kit of claim 3, wherein said bracket extends below said connecting member.

5. The tow dolly fender kit of claim 4, wherein said bracket slidable along the tow dolly arm of the tow dolly.

6. The tow dolly fender kit of claim 5, wherein said front fender and said rear fender having a material selected from the group consisting of an aluminum and a steel.

7. The tow dolly fender kit of claim 6, wherein said bracket having a material selected from the group consisting of an aluminum and a steel.

8. A tow dolly fenders kit comprising:
a front fender;
a rear fender;
a bracket;
a first arm;
a second arm; and
a connecting member;
wherein said front fender having a contoured shape for extending over at least a top portion of a front tow dolly tire;
wherein said rear fender having a contoured shape for extending over at least a top portion of a rear tow dolly tire;
wherein said bracket positioned at a center between said front fender and said rear fender;
wherein said connecting member attached to said bracket;
wherein said front fender connected to said connecting member with said first arm;
wherein said rear fender connected to said connecting member with said second arm; and
wherein said bracket having a first pair of opposing apertures and a second pair of opposing apertures for fastening said bracket to a frame of a tow dolly with a first fastener between said first pair of opposing apertures and a second fastener between said second pair of opposing apertures; and
further wherein said bracket clippable to the frame of the tow dolly for attaching said tow dolly fenders kit to the tow dolly.

9. The tow dolly fenders kit of claim 8, wherein said first arm and said second arm having an adjustable height for adjusting a height of said front fender and said rear fender.

10. The tow dolly fenders kit of claim 9, wherein said front fender having a contoured shape for extending over at least half of the outer circumference of said front tire.

11. The tow dolly fender kit of claim 10, wherein said rear fender having a contoured shape for extending over at least half of the outer circumference of said rear tire.

12. The tow dolly fender kit of claim 11, wherein said bracket extends below said connecting member.

13. The tow dolly fender kit of claim 12, wherein said bracket slidable along the tow dolly arm of the tow dolly.

14. The tow dolly fender kit of claim 13, wherein said front fender and said rear fender having a material selected from the group consisting of an aluminum and a steel.

15. The tow dolly fender kit of claim 14, wherein said bracket having a material selected from the group consisting of an aluminum and a steel.

16. A method of protecting a towed vehicle from debris, the method comprising the steps of:
providing tow dolly fenders kit having a front fender, a rear fender, a bracket, a first arm, a second arm, and a connecting member, wherein said front fender having a contoured shape for extending over at least a top portion of a front tow dolly tire, wherein said rear fender having a contoured shape for extending over at least a top portion of a rear tow dolly tire;
positioning said bracket at a center between said front fender and said rear fender;
attaching said bracket to said connecting member, wherein said bracket having a first pair of opposing apertures and a second pair of opposing apertures;
connecting said front fender to said connecting member with said first arm;
connecting said rear fender to said connecting member with said second arm; and
fastening said bracket to a frame of a tow dolly with a first fastener between said first pair of opposing apertures and a second fastener between said second pair of opposing apertures, wherein said bracket clippable to the frame of the tow dolly for attaching said tow dolly fenders kit to the tow dolly.

17. The method of protecting a towed vehicle from debris of claim 16 further comprising a step of adjusting a height of said front fender and said rear fender.

18. The method of protecting a towed vehicle from debris of claim 17, wherein said front fender having a contoured shape for extending over at least half of the outer circumference of said front tire, and further wherein said rear fender having a contoured shape for extending over at least half of the outer circumference of said rear tire.

19. The method of protecting a towed vehicle from debris of claim 18, wherein said bracket extends below said connecting member.

20. The method of protecting a towed vehicle from debris of claim 19, wherein said bracket slidable along the tow dolly arm of the tow dolly.
